(19) United States
(12) Patent Application Publication
(10) Pub. No.: US 2024/0066533 A1
(43) Pub. Date: Feb. 29, 2024

(54) Inner Spiral Nozzle

(71) Applicant: Full Power Idea Tech Ltd., Zhubei City (TW)

(72) Inventor: Chun-Liang Lai, Zhubei City (TW)

(21) Appl. No.: 17/898,555

(22) Filed: Aug. 30, 2022

(51) Int. Cl. B05B 1/02; B05B 1/34; B05B 9/03

(52) U.S. Cl. CPC B05B 1/02; B05B 1/3405; B05B 9/03

(57) ABSTRACT

The present invention discloses an inner spiral nozzle which is assembled to a corresponding nozzle head at its output position. The nozzle consists of a nozzle body with a pre-determined contour that connects with the nozzle head, and at least one flow channel formed through the end surface of the nozzle body at one side which is connected with the nozzle head and the outside of the nozzle body, and the inner wall of the flow channel is formed with a thread along the extending direction of the flow channel. By the composition of the above-mentioned components, the inner diameter of the flow channel is formed multiple cross-sections with different apertures due to the thread on the wall surface, which can increase the effect of the surface tension of the fluid in the flow channel.

### FIELD OF THE INVENTION

The present invention is in a technical field related to wafer process equipment, more particularly, refers to an inner spiral nozzle.

### BACKGROUND OF THE INVENTION

With the technological improvement of semiconductor fabrication, forming a precise photomicrographic pattern is more dependent on a uniform coating technology of the photoresist material. Since the thickness variation could affect the subsequent processing steps, the uniform coating of the photoresist material is, therefore, more significant. The photoresist is a liquid that is coated on the top of the substrate surface (e.g., on a semiconductor wafer) to form a filmed layer.

It is known that some dispensing methods are used to apply liquid coating material to wafer substrates currently. In some applications, a nozzle head is used to dispense the liquid coating material to submerge the spinning wafer. The aforesaid nozzle head usually has plural ejection ports, and each ejection port is connected to a liquid collecting chamber via a corresponding distribution channel. When pressure is applied to the liquid collecting chamber, the photoresist material in the chamber will flow to each ejection port through each distribution channel and will be applied toward the surface of the substrate.

When the pressure inside the liquid collecting chamber is temporarily halted, the static pressure inside the chamber, together with the surface tension of the liquid coating material, will remain the flow of the liquid coating material on the surface of the dispensing channel and the ejection port. However, due to the vibration of the equipment or the flow of external air, the surface tension of the liquid coating material may change, causing the leaking of the liquid coating material to drip onto the wafer substrate, resulting in an uneven coating on the wafer substrate.

### SUMMARY OF THE INVENTION

In view of the problems and shortcomings of the prior art, the main purpose of the present invention is to provide an inner spiral nozzle, which solves the shortcomings of the prior art by virtue of an innovative design of the structure.

An inner spiral nozzle is provided according to the above purpose, which is assembled to a corresponding nozzle head at its output position. The inner spiral nozzle consists of a nozzle body with a pre-determined contour that can connect with the nozzle head, and at least one flow channel formed through the end surface of the nozzle body at one side which is connected with the nozzle head and the outside of the nozzle body. In addition, the inner wall of the flow channel is formed with a thread along the extensional direction of the flow channel. By the composition of the above-mentioned components, the inner diameter of the flow channel is formed with multiple cross-sections with different apertures due to the thread on the wall surface, which could increase the effect of the surface tension of the fluid in the flow channel.

### BRIEF DESCRIPTION OF THE DRAWINGS

FIG. 1 is a schematic diagram of an embodiment of the present invention combined with a nozzle head;

FIG. 2 is a perspective view of the present invention;

FIG. 3 is a schematic cross-sectional view of the embodiment shown in FIG. 2; and

FIG. 4 is a schematic cross-sectional action diagram of the embodiment shown in FIG. 1.

### DESCRIPTION OF THE PREFERRED EMBODIMENTS

The following is a further description of the embodiment of the inner spiral nozzle of the present invention with reference to the relevant drawings. The various objects in the embodiments are depicted in the proportions, dimensions, deformations, or displacements applicable to the description, rather than in the proportions of the actual components, as indicated. The same and symmetrical configuration of the components in the remaining embodiments are represented by the same number. In addition, the directional terms such as “front, back, left, right, top, bottom, inside, and outside” in the description of each embodiment listed below are in accordance with the specified direction of the view, and cannot be used as an explanation of the restrictions of the invention.

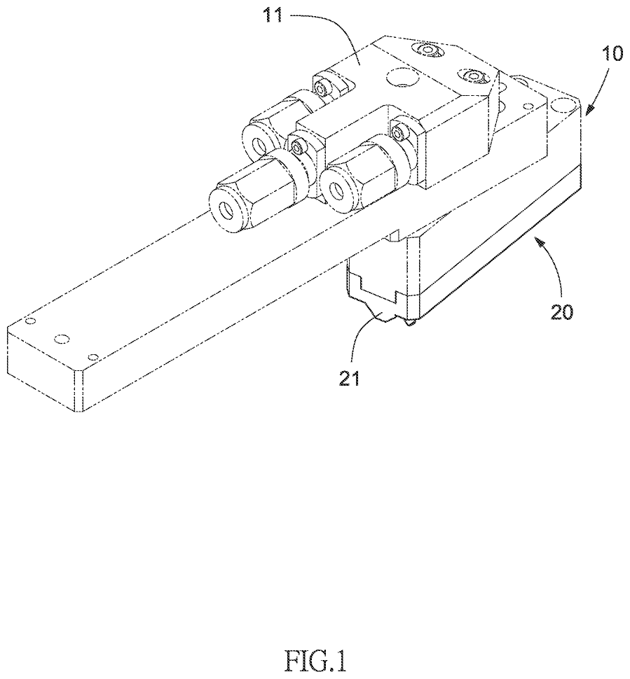

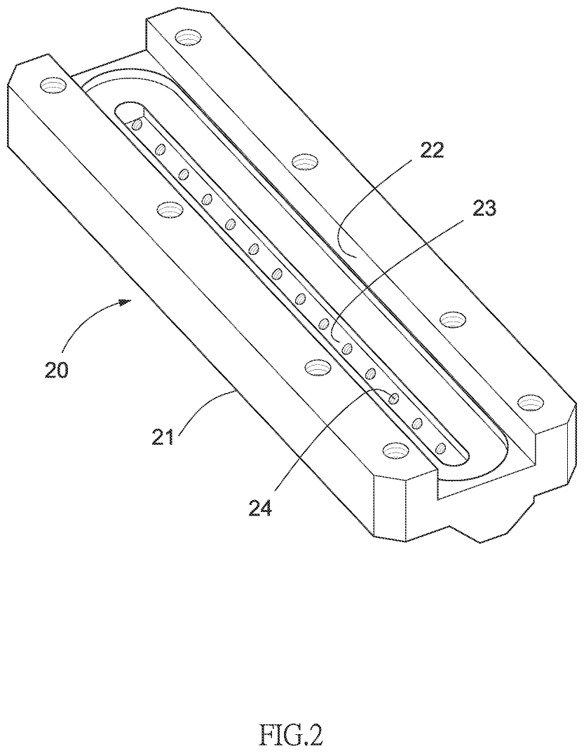

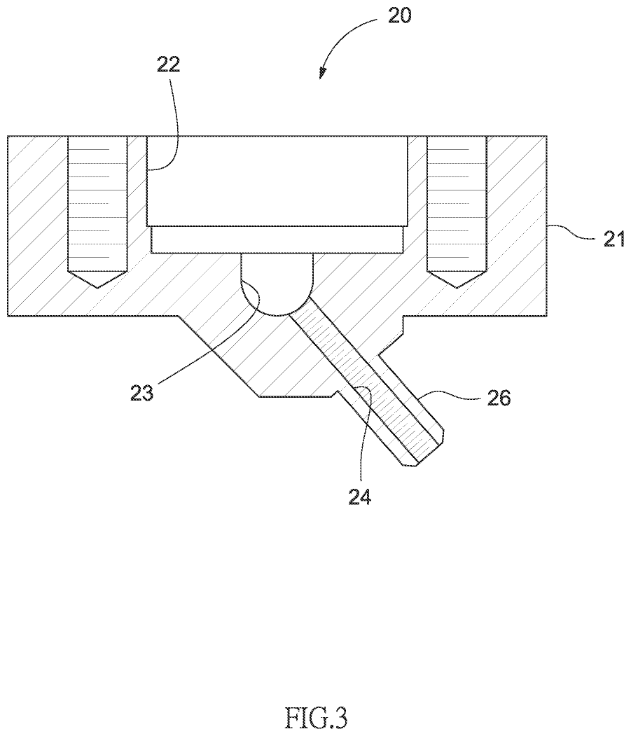

Referring to FIGS. 1 to 4, the inner spiral nozzle of the present invention is implemented with a nozzle head 10 of photoresist coating equipment to regulate the output direction of the liquid photoresist material supplied to the nozzle head 10.

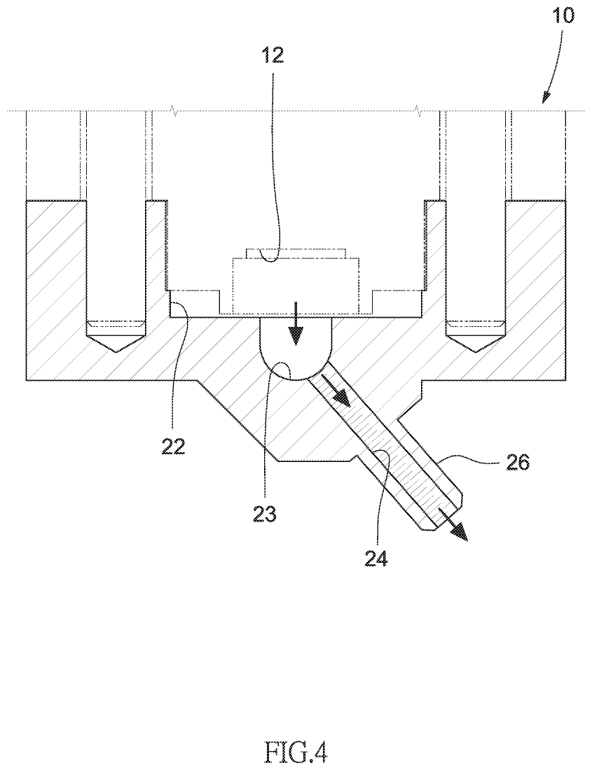

The above-mentioned nozzle head 10 (prior art) has a fluid connector 11 which is provided for connecting pressure gas with at least one liquid photoresist material supply line (not shown), and an output port 12 which is provided for mixing the pressure gas with the liquid photoresist material (as shown in FIG. 4).

The inner spiral nozzle 20 of the present invention includes a nozzle body 21, a fitting groove 22, a liquid collecting chamber 23, at least one flow channel 24, and at least one extension arm 26.

The above nozzle body 21 is with a pre-determined contour and is able to assemble with the nozzle head 10 corresponding to the output port 12.

The above-mentioned fitting groove 22 is recessed along the extending direction of the nozzle body 21 and is formed on the assembly junction of the nozzle body 21 where it is combined with the nozzle head 10. When implemented, the fitting groove 22 with a pre-determined end surface for the nozzle body 21 is matched with the contour of the nozzle head 10, so it can be optionally omitted.

The above liquid collecting chamber 23 is recessed and is formed along the extending direction of the nozzle body 21. When implemented, the liquid collecting chamber 23 is connected with the output port 12 of the nozzle head 10. Optionally, the liquid collecting chamber 23 is formed by recessing from the bottom of the fitting groove 22.

The above flow channel 24 is formed through a pre-determined end surface of the nozzle body 21 which is used for connecting the liquid collecting chamber 23 and the outside of the nozzle body 21. In addition, a thread is formed on the inner wall of the flow channel 24 along the extending direction of the flow channel 24 (no drawing number given).

The above extension arm 26 is formed by extending outward from the pre-determined end surface of the nozzle body 21 at a pre-determined angle, and the flow channel 24 is provided internally for extending the length and direction of the flow channel 24. When implemented, the angle of the free end of the extension arm 26 is selectively between 0 and 180 degrees to the top surface of the nozzle body 21.

When implemented, each flow channel 24 can be designed to optionally connect with the output port 12 of the nozzle head 10 directly, and omit the use of the liquid collecting chamber 23.

The above is an introduction of the various components and assembly method of the inner spiral nozzle in a preferred embodiment provided by the present invention, and the operations of the embodiment are further introduced as follows.

When implemented, the supply lines of the pressure gas and liquid photoresist material (not shown in the drawings) are connected with the fluid connector 11 of the nozzle head 10 respectively, so when the pressure gas and liquid photoresist material enter the nozzle head 10 through the output port 12 and converge at the liquid collecting chamber 23 of the inner spiral nozzle 20, then the liquid photoresist material will be ejected in a preset direction through the flow channel 24.

When the pressure gas temporarily halts the supply, the liquid photoresist material in the flow channel 24 of the inner spiral nozzle 20 will remain in the flow channel 24 by its own adhesion, surface tension, and so forth. Furthermore, due to the design of thread on the wall of the flow channel 24, the flow channel 24 forms multiple cross-sections with different apertures, which increases the effect of the surface tension of the liquid photoresist material, and allows the liquid photoresist material to further stay in the flow channel 24, to avoid the liquid photoresist material from leaking and dripping.

With the configuration of the extension arm 26 corresponding to the flow channel 24, it can be used as an extension of the length for the flow channel 24, and it also can allocate the output angle of the flow channel 24 in accordance with the environment in which the nozzle head 10 is used.

While the present invention has been described by means of specific embodiments, numerous modifications and variations could be made thereto by those skilled in the art without departing from the scope and spirit of the present invention set forth in the claims.

What is claimed is:

1. An inner spiral nozzle, which is assembled to a corresponding output port of a nozzle head, comprising:
a nozzle body having a pre-determined contour and assembled with the nozzle head; and
at least one flow channel is formed through an end surface of the nozzle body at one side and connects with the output port and the outside of the nozzle body, and a thread is formed on the inner wall of the flow channel along the extending direction of the flow channel.

2. The inner spiral nozzle according to claim 1, wherein a liquid collecting chamber is recessed on the assembly junction of the nozzle body where it is combined with the nozzle head, and the liquid collecting chamber is connected with the nozzle head and the flow channel.

3. The inner spiral nozzle according to claim 1, wherein a fitting groove is recessed on the assembly junction of the nozzle body where it is combined with the nozzle head.

4. The inner spiral nozzle according to claim 1, wherein the nozzle body has at least one extension arm extending outward, at a pre-determined angle, from the pre-determined end surface of the nozzle body, and the extension arm is internally provided with the flow channel.

5. The inner spiral nozzle according to claim 4, wherein the free end of the extension arm is at an angle between 0 and 180 degrees to the top surface of the nozzle body.
